(19) United States
(12) Patent Application Publication
(10) Pub. No.: US 2006/0098590 A1
(43) Pub. Date: May 11, 2006

(54) Communication system

(75) Inventors: Martin Hans, Hildesheim (DE); Achim Luft, Braunschweig (DE)

Correspondence Address: DARBY & DARBY P.C., P. O. BOX 5257, NEW YORK, NY, 10150-5257, US

(73) Assignee: Infineon Technologies AG, Munich (DE)

(21) Appl. No.: 11/215,350

(22) Filed: Aug. 29, 2005

(30) Foreign Application Priority Data
Aug. 30, 2004 (DE) 10 2004 041 882.9

(51) Int. Cl. H04L 12/16

(52) U.S. Cl. 370/260

(57) ABSTRACT

A conference communication system which has a conference media mixing device which is set up to use media rules to mix together communication data sent during a conference and to use evaluation rules to evaluate response communication data sent during a survey which is performed during the conference.

### CROSS-REFERENCE TO RELATED APPLICATION

This application claims priority to German Patent Application Serial No. 10 2004 041 882.9, which was filed on Aug. 30, 2005.

### FIELD OF THE INVENTION

The invention relates to a communication system, a method for performing a survey, a conference media mixing device and a method for evaluating response communication data.

### BACKGROUND OF THE INVENTION

In modern communication systems, such as the Internet protocol multimedia subsystem (IMS), provision is made for conference communication services to be provided.

Such conference communication services allow a plurality of subscribers to communicate with one another using communication terminals.

During a conference provided using a conference communication service, typically a plurality of conference participants simultaneously generate communication data. Since the communication terminals used by the conference participants typically have just one or very few output options for communication data, the communication data need to be mixed together before they are output by communication terminals. This process is called media mixing. If a plurality of conference participants generate audio data, for example, then these data may be summed at particular audio volumes, for example, and output using the output option of a communication terminal.

In the conference communication system described in J. Rosenberg: draft-ietf-sipping-conferencing-framework-01, Internet Draft der IETF, the rules used to perform media mixing are stored in a database on the conference communication system. These rules are called media rules (media policy). It is possible for different media rules to be stipulated for different conference participants, that is to say that communication data which are intended for a particular conference participant, that is to say are intended to be sent to the communication terminal used by the conference participant for output, are mixed using media rules which are specific to this conference participant.

Conferences frequently require that ballots for the conference participants be performed. Apparatuses provided specifically for this purpose are known which allow ballots to be performed electronically.

However, apparatuses provided specifically for ballots have the drawback that these apparatuses provide only limited ballot options and evaluation options.

It is also necessary for these apparatuses to be available in addition to the communication terminals used by the conference participants.

DE 4333245 A1 discloses a data capture and evaluation apparatus for recording people participating in a meeting and for recording and evaluating the votes cast by these people which has portable data capture and display units and in which information is transmitted from and to the portable data capture and display units using infrared signals, so that transmission interference is avoided.

EP 580397 A2 discloses a conference system in which the participants in a conference are provided with input means, which input means can be used by the participants to alter conference parameters and, in particular, to vote.

DE 10156414 discloses a method and an apparatus for casting votes in a survey, the votes being cast using a mobile station and being transmitted to an evaluation unit using at least one radio link.

U.S. Pat. No. 5,953,393 A1 discloses a personal telephone messaging agent which uses a telephone system to carry out planning tasks and coordination tasks and to acquire information.

U.S. Pat. No. 6,324,266 B1 discloses a data collection system which has a data processing system for receiving data which are sent using radio telephones and for generating statistical information relating to the data received. The data collection system can be used for ballots, in particular.

U.S. Pat. No. 6,406,302 B1 discloses a method for collecting information and interchanging information between two individuals. In this case, the two individuals give responses to questions, and the responses are analyzed and, by way of example, matching responses are indicated.

DE 4321801 C1 discloses an apparatus for wirelessly recording the reaction of a large number of people which has a polling unit and a multiplicity of terminals, which terminals change over to a ready-to-send state only after receipt of a polling signal which has a particular code and which is transmitted by the polling unit.

M. Handley, V. Jacobson: “SDP: Session Description Protocol”, Request For Comment der IETF RFC 2327, describes the SDP (Session Description Protocol).

D. Crocker et al.: “Augmented BNF for Syntax Specifications: ABNF”, Request For Comment der IETF RFC2234, contains a description of the Backus-Naur form, which can be used for syntax specifications.

FR 2573234 A discloses an apparatus in which information is sent from participants in a conference sitting at their desks to a data processing unit. The data processing unit stores the association between the desks and the information about the participants.

US 2003 0069828 A1 discloses a method for distributing network resources in which users can bid for the allocation of a network resource.

WO 2001069485 A1 discloses methods and apparatuses for producing an interactive business process which allow a user to use definition instructions to produce a user-defined business process.

EP 0 561 649 A2 describes a conference system in which messages from a conference are stored with references to referenced messages. In addition, EP 0 561 649 A2 describes the option of using a program transmitted during the conference to provide a ballot.

US 2004/0047461 A1 describes a conference system in which various options for allocating communication rights are presented.

### SUMMARY OF THE INVENTION

A communication system having a conference server, a database, and a conference media mixing device. The conference server is set up to provide a conference for a plurality of conference participant terminals, wherein each of the plurality of the conference participant terminals has a signaling device which is set up to send response communication data using a prescribed response syntax during a survey which is performed during the conference . . . The database contains media rules which are to be used to mix together communication data, which are sent by the plurality of conference participant terminals during the conference before they are output, wherein the media rules have evaluation rules which are to be used to evaluate the response communication data. The conference media mixing device is set up to use the media rules to mix together the communication data and to use the evaluation rules to evaluate the response communication data taking into account the response syntax.

### BRIEF DESCRIPTION OF THE DRAWINGS

Exemplary embodiments of the invention are illustrated in the figures and are explained in more detail below.

FIG. 1 shows a conference communication system based on an exemplary embodiment of the invention.

FIG. 2 shows a conference communication system based on an exemplary embodiment of the invention.

FIG. 3 shows a flowchart based on an exemplary embodiment of the invention.

### DETAILED DESCRIPTION OF PREFERRED EMBODIMENTS OF THE INVENTION

The invention is based on the problem of allowing surveys to be performed flexibly and efficiently during conferences.

The problem is solved by a communication system, a method for performing a survey, a conference media mixing device and a method for evaluating response communication data having the features in accordance with the independent patent claims.

The invention provides a communication system having a conference server, where the conference server is set up to provide a conference for a plurality of conference participant terminals. The communication system has a database which contains media rules which are to be used to mix together communication data, which are sent by the plurality of conference participant terminals during the conference, before they are output. Each of the plurality of the conference participant terminals has a signaling device which is set up to send response communication data based on a prescribed response syntax during a survey which is performed during the conference. The media rules have evaluation rules which are to be used to evaluate the response communication data and the communication system has a conference media mixing device which is set up to use the media rules to mix together the communication data and to use the evaluation rules to evaluate the response communication data taking into account the response syntax.

An idea forming the basis of the invention can clearly be seen in that the responses which the users of the plurality of conference participant terminals give to the questions in the survey using the plurality of conference participant terminals are sent as media streams and are evaluated during the media mixing. Clearly, the type of evaluation of the response communication data is thus defined by media rules which are used to perform the mixing of media streams.

One advantage of the invention is that in a conference communication system the already existing media mixing device, that is to say the media mixer, which is used to mix together communication data sent during the conference before they are output, is used to perform the evaluation of the response communication data. To implement the evaluation by combining existing methods, the mechanisms of the already existing media mixing device are used. Hence, no new element in the conference communication system is required in order to be able to provide evaluation services, and it is not necessary to change the architecture of the conference communication system.

Various evaluation methods may be used and freshly combined, which allows evaluation services.

The type of evaluation is defined in the media rules, for example using evaluation scripts, and can be stipulated, by way of example, by participants in the conference who are authorized to do so.

Examples of possible evaluations are:
Determination of the user whose response (which has been given in the form of a number) is closest to a particular number.
Determination of the user whose response (which has been given in the form of a number) is highest, that is to say clearly which user has submitted the highest bid.
Determination of a voting result, that is to say of the response given by a majority of users, for example.

Further examples of possible evaluations are given in the description of exemplary embodiments.

The response syntax used to send the response communication data is stipulated, by way of example, at the start of the survey by means of message interchange between the conference server and the communication subscriber terminals, for example by means of message interchange based on the SIP (Session Initiation Protocol).

Preferred developments of the invention can be found in the dependent claims. The further refinements of the invention, which are described in connection with the communication system provided, also apply mutatis mutandis to the method for performing a survey, to the conference media mixing device and to the method for evaluating response communication data.

It is preferred for the communication system to have a further database containing membership rules and for the conference server to be set up to provide the conference using the membership rules.

Preferably, the response syntax is defined using the SDP (Session Description Protocol).

Another preference is that the signaling device in each conference participant terminal is set up to send the response communication data as a reaction to the receipt by the respective conference participant terminal of a question transmission sent during the survey and to a response input from the user of the respective conference participant terminal.

Another preference is that the communication terminal has an output device which is set up to use the question transmission to put a question to the user of the respective conference participant terminal as a reaction to the receipt of the question transmission.

The question transmission can be effected in the form of a media stream or in the form of an instant message, for example.

Preferably, the output device is set up to ask the question using text data, audio data, video data and/or still-picture data contained in the question transmission.

Another preference is that the user input is a text input, a number input, a selection from a plurality of options and/or the recording of a voice message.

The selection of a plurality of options may be clicking on an image from a plurality of images, for example.

Another preference is that the evaluation rules specify those elements of the communication system to which the evaluated response communication data are to be sent, and the media mixing device is set up to use the evaluation rules to send the evaluated response communication data.

By way of example, the result of the evaluation can be sent to the conference participant terminal of a privileged user, who forwards the result to users whom he has selected.

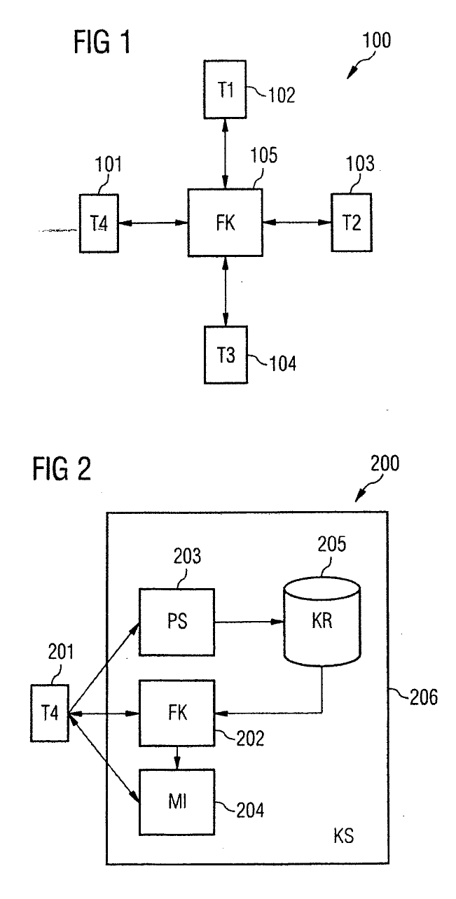

FIG. 1 shows a conference communication system 100 based on an exemplary embodiment of the invention.

The conference communication system 100 is in a form as described by the IETF (Internet Engineering Taskforce) in J. Rosenberg: draft-ietf-sipping-conferencing-framework-01, Internet Draft der IETF.

A plurality of communication terminals 101, 102, 103, 104 used by conference participants communicate using a central unit, a conference focus 105. The conference focus 105 is used to provide a conference in which the conference participants participate. The conference focus 105 is addressed using a conference address, which is simultaneously the address of the conference provided.

The plurality of communication terminals 101, 102, 103, 104 and the conference focus 105 communicate using the SIP (Session Initiation Protocol). The SIP is used to interchange connection management messages (call control messages) between the conference focus 105 and the plurality of communication terminals 101, 102, 103, 104. In addition, the conference focus 105 informs the plurality of communication terminals 101, 102, 103, 104 about conference events, for example about the fact that a new conference participant is participating in the conference. The information about conference events is called notification.

The more precise operation of the conference communication system 100 is explained below with reference to FIG. 2.

FIG. 2 shows a conference communication system 200 based on an exemplary embodiment of the invention.

The conference communication system 200 has a plurality of communication terminals, from which only one communication terminal 201 is shown by way of example for reasons of simplicity.

In line with FIG. 1, the communication terminal 201 is coupled to a conference focus 202. In addition, the communication terminal 201 is coupled to a policy server 203 and to a mixer 204. The policy server 203 and the conference focus 202 are coupled to a database 205.

In this exemplary embodiment, the policy server 203, the conference focus 202, the mixer 204 and the database 205 are combined in a conference server 206, but may also be in separate form.

The communication terminal 201 corresponds to one of the plurality of communication terminals 101, 102, 103, 104 from FIG. 1.

The other communication terminals in the plurality of communication terminals 101, 102, 103, 104 are coupled to the conference server 206 in similar fashion to the communication terminal 201.

Communication data are interchanged in the form of media streams, for example audio streams or video streams, between the plurality of communication terminals 101, 102, 103, 104. The media streams are transmitted using a further central unit, the mixer 204. The mixer 204 collects the media streams sent by all communication terminals from the plurality of communication terminals 101, 102, 103, 104, mixes them together and sends the mixed media streams to the plurality of communication terminals 101, 102, 103, 104. By way of example, the mixer 204 mixes together audio streams which have been sent from a first communication terminal and a second communication terminal from the plurality of communication terminals 101, 102, 103, 104 by addition and then sends the mixed audio streams to a third communication terminal from the plurality of communication terminals 101, 102, 103, 104.

The conference is performed using particular conference rules (conference policy). The conference rules have membership rules (membership policy) and media rules (media policy).

The membership rule is used to determine, by way of example, who may participate in the conference, who may invite others to join the conference, to whom what notifications are sent, who may determine what media streams are forwarded using the mixer 204, and who may alter the conference rules.

The media rules specify how the media streams are mixed together during the conference.

The conference rules are stored in the database 205. The database 205 is managed by the policy server 203. The conference rules can be altered by conference participants who are privileged to do so. The policy server 203 is arranged centrally, like the conference focus 202 and the mixer 204, and is in this exemplary embodiment combined with the conference focus 202 and the mixer 204 in the central conference server 206, as mentioned.

In the case of conferences with a large number of conference participants, it is important that not all conference participants communicate at the same time, that is to say send communication data to other conference participants. For this reason, in the conference communication system 100 shown in FIG. 1, only some of the conference participants are given the right to communicate at the same time. The right to communicate is either allocated automatically according to particular rules by the conference focus 202 or is allocated by a conference participant who is privileged to do so, who is called the moderator. The allocation of communication rights is also called “floor control”.

When, depending on the embodiment, the conference focus 202 or the moderator has decided how the communication rights are allocated, that is to say which conference participants are allowed to communicate at a particular time, this is communicated to the policy server 203. The policy server 203 changes the media rules accordingly. On the basis of the media rules, the mixer 204 is controlled using the conference focus 202 such that the mixer 204 mixes together the media streams in line with the allocated communication rights.

The media rules are defined in the form of mixing primitives or are compiled from mixing primitives.

The text below explains the performance of a survey in line with an exemplary embodiment of the invention.

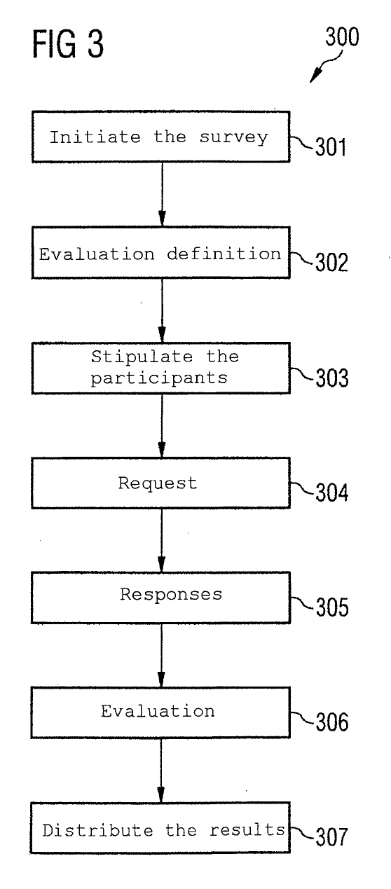

FIG. 3 shows a flowchart 300 based on an exemplary embodiment of the invention.

The sequence shown illustrates the plurality of phases 301-307 which make up a conference survey based on this exemplary embodiment. In this exemplary embodiment, the plurality of phases 301-307 are performed in the order illustrated, but may also be performed in another order in other embodiments.

In step 301, a survey session is initiated using the SIP (Session Initiation Protocol).

A survey session takes place during a conference and has a plurality of survey session participants who are conference participants in the conference and who use communication terminals to participate in the survey session.

During a survey session, it is possible for a plurality of survey sections to be performed, with a survey section comprising an enquiry (or question) to which a response needs to be given, for example.

In this example, it is assumed for the sake of simplicity that as an example just one question is asked during the survey session. When there are a plurality of questions during the survey session, the corresponding sequence steps are performed in similar fashion for each question.

SIP messages interchanged when the survey session is initiated are used to describe the media streams used during the survey session, so that the implicated conference communication system elements of the conference communication system which is used to provide the conference and which is in the form shown in FIG. 1, for example, agree on a uniform transmission format for the media streams.

The media streams are described using the SDP (Session Description Protocol), as described in M. Handley, V. Jacobson: “SDP: Session Description Protocol”, Request For Comment der IETF RFC 2327.

In this exemplary embodiment, the description of the media streams is in the form shown in table 1. This description is used to specify the enquiry media streams used during the survey session for enquiries, that is to say questions, and response media streams used for responses.

TABLE 1

v = 0
o = survey conductor 2890844526 2890842807 IN IP4
126.16.64.4
s = opinion poll
i = a survey
u = http://www.companyXYZ.com/conference/survey.html
e = surveyconductor@companyXYZ.com (survey conductor)
c = IN IP4 224.2.17.12/127
t = 2873397496 2873404696
m = data 49170 udp vt

In particular, the description of the media streams in line with Table 1 is used to specify that
the user “survey conductor” is controlling the survey session (row 2);
the subject of the survey session is “opinion poll” (row 3);
this is “a survey” (row 4); this is textual information for users who are participating in a survey or for the communication terminals used by the users. The information has no further significance within the context of the conference communication system.
further information can be found at http://www.companyXYZ.com/conference/survey.html (row 5);
the e-mail address of the user who is conducting the survey is “surveyconductor@companyXYZ.com (row 6);
the survey can be found on the Internet using IP Version 4 at the address 224.2.17.12/127 (row 7);
the survey session lasts from the time 2873397496 to the time 2873404696 (row 8);
the media streams sent during the survey session are of the “data” type and are transmitted via port 49170 using the UDP (User Datagram Protocol) in the format “vt” (voting) (row 9).

The indicated survey session period (row 8) determines the duration of the survey session and not the response period for the responses to the question (as mentioned, it is assumed in this example that only one question is asked), that is to say the period in which responses to the question are given. In general, the survey session period is longer than the period for the responses to the question. The survey session period may match the period of the entire conference during which the survey session takes place, for example. If the response period is outside of the survey session period then the response period is shortened by the conference focus 202 such that the response period is inside of the survey session period.

In step 302, the type of evaluation of the responses to the question which are given during the survey session is stipulated by a user privileged to do so using the media rules. This requires that the privileged user be permitted to stipulate the media rules accordingly, that is to say has appropriate rights to stipulating the media rules.

The privileged user can stipulate the evaluation through evaluation primitives or through rules compiled from evaluation primitives, for example using a communication terminal which he uses.

Examples of evaluation primitives are:
determination of the frequencies of particular responses;
calculation of the mean value of numerical responses (that is to say of responses which are given in the form of a number);
determination of the median of numerical responses;
determination of the maximum of numerical responses;
determination of the minimum of numerical responses;
forwarding of the set of all responses (without evaluation);
determination of the conference participants who have given a particular response;
determination of the conference participants whose response is closest to a particular response.

The available evaluation primitives may be requested from the conference focus 202 by users who are privileged to do so. As a response to a request for the available evaluation primitives, the conference focus 202 supplies a textual description of the available evaluation primitives.

The mixer 204 provides a few standard sets of evaluation primitives. The mixer 204 may also contain a definition of further evaluation primitives. In addition, the mixer 204 may also provide compiled evaluation primitives, for example the evaluation primitive: determination of the top quarter of numerical responses (that is to say the limit of the third quartile).

A user privileged to do so, for example the user privileged to stipulate the evaluation, also uses the media rules to stipulate that period in which the responses to be evaluated can be given by the conference participants using the communication terminals used by the conference participants, that is to say he stipulates the response period. Responses which are given outside of the stipulated response period are not included in the evaluation of the responses to the enquiry.

In step 303, the survey session participants who are authorized to respond are stipulated, since possibly not all survey session participants are authorized to respond (or authorized to vote) to every one of the questions asked during the survey session.

For this reason, a survey moderator determines which of the survey session participants are authorized to respond to the subsequent question. The survey moderator thus allocates the communication rights for the response media streams in the survey session, that is to say he stipulates which participants may send media streams as a response to the question.

In steps 304 and 305, in plain terms the actual survey is performed by a survey conductor. The survey conductor sends the question in the form of question data to the communication terminals of the conference participants who are to be asked (question transmission). The question data contain a question text, the specification of a participant response period and a specification of the possible responses to the question. The question text is presented to the question participants, that is to say to the survey session participants authorized to respond, who have been stipulated in step 303, on the communication terminals used by the question participants. The possible responses are presented to the question participants for selection or for input.

The question data are sent in the form of a special media stream which contains information about the question, for example the question text, in the form of text.

The format of this text is in the form shown in Table 2, for example. Table 2 defines the format of the text in the Backus-Naur form (BNF) defined in D. Crocker et al.: “Augmented BNF for Syntax Specifications: ABNF”, Request For Comment der IETF RFC2234.

The equals sign (‘=’) defines elements. Square brackets [] identify optional elements. An asterisk (‘*’) specifies a repetition. A forward slash (‘/’) separates alternative elements.

TABLE 2

Enquiry = “Q” “;” question text “;” response time “;”
responses
Question text = text
Text = *ALPHANUM
Response time = start time “;” end time
Start time = posinteger
End time = posinteger
Responses = response type “;” number of responses [“;”
parameter]
Response type = “selection type”/ “integer type”/
“real number type”/ “text type”
Number of responses = posinteger
Parameter = (Text *(“;” text))/limits
Limits = (integer integer)/(real number real number)
posinteger = 1*NUM
Integer = [“+”/“−”] 1*NUM
Real number = [“+”/“−”] 1* NUM [“.” 1*NUM]

In Table 2, ALPHANUM represents an alphanumeric character and NUM represents a digit. The character ‘Q’ (question) signals that this is an enquiry.

In line with the format described in Table 2 for an enquiry, an enquiry could take the following form, for example:

Q; What is the name of the world's highest mountain?;123456789;123458470;selection type;1;MontBlanc;Mount Everest;Brocken

The specified participant response period (as shown in row 4 from Table 2) indicates the period in which the response needs to be given. If the participant response period is limited, it is indicated to the question participants using the respective communication terminals.

The specified participant response period is used only to inform the question participants. It is not necessary for the specified participant response period to match the response period defined in step 302 during the evaluation definition using the media rules. However, in most cases it is useful to have a match. By way of example, a mismatch is useful when different question participants are intended to respond within different periods. The participant response period specified in a question sent to a question participant indicates the question participant's individual period for a response, and the response period defined in step 302 for the responses comprises all individual participant response periods.

As mentioned, in this example the enquiry is sent using a media stream, but in another embodiment it may also be sent using instant messages.

In another embodiment, the question is not asked in the form of a question text, but rather the question is asked using other media, for example using videos or images.

The following are examples of possible responses to a question:
a set of texts;
an integer from a first value to a second value;
a real number from a first value to a second value;
any text.

Actions other than the input of text or numbers may also be defined as possible responses, for example clicking on an image or recording a voice message.

The question participants signal their respective response to the question asked using a special response media stream using their respective communication terminal. The response media stream contains the response data in this exemplary embodiment in a text format which is in a form as shown in Table 3. The text format is defined using the Backus-Naur form, as in Table 2.

TABLE 3

Response = “A” “;” response type “;” number of
responses “;” values
Response type = “selection type”/”integer type”/
“real number type”/ “text type”
Number of responses = posinteger
Values = value *(“;” value)
Value = posinteger/integer/real number/text
posinteger = 1*NUM
‘A’ (answer) signals that this is a response.

A response to the example question above (What is the name of the world's highest mountain?) could accordingly take the following form:

A;selectiontype;1;2

The response to a selection question may alternatively also be given as text. The above example's corresponding response to the example question is accordingly:

A;texttype;1;Mount Everest

If the participant response period is specified inconsistently in the question data, since the end time is less than or equal to the start time, one embodiment has provision for the participant response period used to be the survey session period. In this case, this mechanism may be used intentionally to set the participant response period to the survey session period. This can be achieved, by way of example, by specifying the start time and the end time as 0 in the question data.

Typically, the survey conductor is also the privileged user who defines the evaluation in step 302, and he is also the survey moderator, who determines which survey session participants are authorized to respond to a particular question.

In step 306, the responses given to the question are evaluated.

For the purpose of evaluation, the conference focus 202 reads the media rules stipulated by the user who is privileged to do so from the database 205 for evaluation. Next, the conference focus 202 communicates these media rules, which are to be used to perform the evaluation, to the mixer 204, taking into account the stipulation (made by the survey moderator) regarding which survey session participants are authorized to vote.

The mixer 204 applies the media rules to the given responses for the purpose of evaluation.

The responses are transmitted to the mixer 204 in the form of response media streams. If all survey session participants who are authorized to respond have given responses in the response period defined by the media rules in step 302 or if the response period has elapsed then the responses given are evaluated in the mixer 204.

In another embodiment, the responses are evaluated not after a particular period but rather only when all question participants who are authorized to respond have responded. Which of the two options is to be implemented can be stipulated in step 302 in the media rules during the evaluation definition. If a consistent finite response period is indicated in the media rules, the evaluation is performed as soon as all question participants who are authorized to vote have responded or as soon as the indicated response period has elapsed or as soon as the survey session is terminated. If a consistent finite response period is not indicated in the media rules, for example because the indicated end time is less than or equal to the indicated start time, the evaluation is first carried out as soon as all survey session participants who are authorized to respond have responded or as soon as the survey session is terminated.

In step 307, the results of the survey performed are distributed.

The evaluation rules stipulated in step 302 by the user who is privileged to do so, the party privileged for evaluation, that is to say media rules for evaluating the responses, also specify to whom the results of the survey, that is to say the results of the evaluation, are sent. The mixer 204 sends the results of the evaluation which it has performed in appropriate fashion, for example to specified communication terminals.

There may be a stipulation, for example, that the results are sent only to the communication terminal of the survey conductor. The surveyor conductor can then distribute the results to the survey session participants or to other entities. Before this distribution, the survey conductor may also condition the results.

1-11. (canceled)

12. A communication system comprising:
a conference server set up to provide a conference for a plurality of conference participant terminals, wherein each of the plurality of the conference participant terminals has a signaling device which is set up to send response communication data using a prescribed response syntax during a survey which is performed during the conference;
a first database which contains media rules which are to be used to mix together communication data, which are sent by the plurality of conference participant terminals during the conference before they are output, wherein the media rules have evaluation rules which are to be used to evaluate the response communication data; and
a conference media mixing device which is set up to use the media rules to mix together the communication data and to use the evaluation rules to evaluate the response communication data taking into account the response syntax.

13. The communication system as claimed in claim 12, further comprising a second database containing membership rules, wherein the conference server is set up to provide the conference using the membership rules.

14. The communication system as claimed in claim 12, wherein the response syntax is defined using the SDP (Session Description Protocol).

15. The communication system as claimed in claim 12, wherein the signaling device in each conference participant terminal is set up to send the response communication data as a reaction to the receipt by the respective conference participant terminal of a question transmission sent during the survey and to a response input from the user of the respective conference participant terminal.

16. The communication system as claimed in claim 15, further comprising an output device which is set up to use the question transmission to send a question to the user of the respective conference participant terminal as a reaction to the receipt of the question transmission.

17. The communication system as claimed in claim 16, wherein the output device is set up to ask the question using text data, audio data, video data and/or still-picture data contained in the question transmission.

18. The communication system as claimed in claim 15, wherein the user input is a text input, a number input, a selection from a plurality of options and/or the recording of a voice message.

19. The communication system as claimed in claim 12, wherein the evaluation rules also specify those elements of the communication system to which the evaluated response communication data are to be sent, and the media mixing device is set up to use the evaluation rules to send the evaluated response communication data.

20. A method for performing a survey during a conference provided by means of a conference server in a communication system, the method comprising the steps of:
a conference media mixing device using media rules, which are stored in a database and are to be used to mix together communication data, which are sent by a plurality of conference participant terminals during the conference, before the communication data are output, and wherein the media rules have evaluation rules, to mix together the communication data sent by the plurality of conference participant terminals;
the plurality of conference participant terminals sending response communication data using a prescribed response syntax during a survey which is performed during the conference; and
the conference media mixing device using the evaluation rules which are to be used for evaluating the response communication data to evaluate the response communication data taking into account the response syntax.

21. A conference media mixing device in a communication system having a conference server which is set up to provide a conference for a plurality of conference participant terminals and a database which contains media rules which have evaluation rules, wherein the media rules are to be used to mix together communication data, which are sent by the plurality of conference participant terminals during the conference, before the communication data are output, wherein the conference media mixing device is set up to use,the media rules to mix together the communication data, and to use the evaluation rules which are to be used for evaluating response communication data, which are sent using a prescribed response syntax by the conference participant terminals during a survey which is performed during the conference, to evaluate the response communication data taking into account the response syntax.

22. A method for evaluating response communication data sent using a prescribed response syntax by a plurality of conference participant terminals during a survey which is performed during a conference provided for the conference participant terminals by a conference server in a communication system, the method comprising the steps of:
using media rules, which are stored in a database and have evaluation rules, to mix together communication data, which are sent by the plurality of conference participant terminals during the conference, before the communication data are output; and
using the evaluation rules, which are to be used for evaluating the response communication data, to evaluate the response communication data taking into account the response syntax.

23. A communication system comprising:
a conference server set up to provide a conference for a plurality of conference participant terminals, wherein each of the plurality of the conference participant terminals has a signaling device which is set up to send response communication data using a prescribed response syntax during a survey which is performed during the conference;
a first database which contains media rules which are to be used to mix together communication data, which are sent by the plurality of conference participant terminals during the conference before they are output, wherein the media rules have evaluation rules which are to be used to evaluate the response communication data; and
a conference media mixing means using the media rules for mixing together the communication data and using the evaluation rules for evaluating the response communication data taking into account the response syntax.
